(19) United States
(12) Patent Application Publication
(10) Pub. No.: US 2013/0175734 A1
(43) Pub. Date: Jul. 11, 2013

(54) MOLDING APPARATUS HAVING A COMPENSATING STRUCTURE

(71) Applicant: Pierre Glaesener, Bissen (LU)

(72) Inventor: Pierre Glaesener, Bissen (LU)

(73) Assignee: HUSKY INJECTION MOLDING SYSTEMS LTD, Bolton, ON (CA)

(21) Appl. No.: 13/810,571

(22) PCT Filed: Jun. 2, 2011
(86) PCT No.: PCT/CA11/50337

§ 371 Date: Jan. 16, 2013

Related U.S. Application Data
(60) Provisional application No. 61/371,189, filed on Aug. 6, 2010.

(51) Int. Cl. B29C 45/04

(52) U.S. Cl. CPC B29C 45/04
USPC 264/313; 425/149

(57) ABSTRACT

Embodiments of the present invention teach a molding apparatus for producing a molded article from a molding material. The molding apparatus comprises an inner core (108) and an outer core (110) for defining a portion of a molding cavity (106) for defining the molded article: the inner core (108) including a compensator (120), the compensator (120) being configured to: retract to a retracted position responsive to the pressure of the molding material being injected into the molding cavity (106); and extend to an extended position responsive to the shrinkage during solidification of the molding material in the molding cavity.

### TECHNICAL FIELD

The non-limiting embodiments disclosed herein generally relate to a molding apparatus, and more particularly to a molding apparatus having a compensating structure.

### BACKGROUND

Molding is a process by virtue of which a molded article can be formed from molding material by using a molding system. Various molded articles can be formed by using an injection molding process, for example. One example of a molded article that can be formed, for example, from Polyethylene Teraphalate (PET) material is a preform that is capable of being subsequently blown into a beverage container, such as, a bottle and the like. Another example of a molded article that can be produced using injection molding (or other molding process) is a closure suitable for releasably closing a beverage container, such as, for example, a beverage bottle blow-molded from the afore-mentioned preform.

As an illustration, injection molding of a molding material involves heating the molding material to a generally homogeneous molten state and injecting, under pressure, the so-melted molding material into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected molding material. The molding cavity has a shape that substantially corresponds to a final cold-state shape of the molded article to be molded. The so-injected molding material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected from the cavity and eventually off of the core piece. Ejection structures are known to assist in removing the molded articles from the core halves. Examples of the ejection structures include stripper plates, ejector pins, etc. A combination of an inner core, an outer core and sliding split mold inserts are used for enabling ejection of the closure.

A detailed description of known components of a typical injection molding system may be referenced, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-10581-3), (iii) “Injection Molding Systems” 3rd Edition authored by JOHANNABER (ISBN 3-446-17733-7) and/or (iv) “Runner and Gating Design Handbook” authored by BEAUMONT (ISBN 1-446-22672-9).

U.S. Pat. No. 4,470,936 issued to Potter on Sep. 11, 1984 discloses a hot runner injection molding apparatus for coinjecting two thermoplastic materials sequentially through separate channels to form at least a two-layer sandwich material is provided. There is a valve means for instantaneously switching the flow of thermoplastic material from one channel to the other channel, the valve means preferably comprising a shuttle ball member.

U.S. Pat. No. 7,293,981 issued to Niewels on Nov. 13, 2007 discloses a method and apparatus for compressing melt and/or compensating for melt shrinkage in an injection mold are provided. The apparatus includes a cavity mold portion adjacent a cavity plate, a core mold portion adjacent a core plate, a mold cavity formed between the mold portions, and at least one piezoceramic actuator disposed between either or both of the core plate and the core mold portion and the cavity plate and the cavity mold portion. A controller may be connected to the at least one piezoceramic actuator to activate it, thereby causing the mold cavity volume to decrease, compressing the melt.

US patent application 2009/0022843 published to Mai et al on Jan. 22, 2009 discloses a compensating core for use with a molding system and the molding system incorporating same. A core insert for use in a molding system is provided. The core insert comprises a core base for defining, in use, a portion of a molding cavity; a core support for supporting, in use, the core base relative to a core plate of the molding system; a compensator associated, at least partially, with the core support to permit at least a degree of axial movement to the core base.

U.S. Pat. No. 7,090,800 issued to Clarke on Aug. 15, 2006 teaches a mold, a molding machine and a method of molding a plastics material in a mold cavity, which relies primarily on movement of a part of the mold to provide the pressure necessary to force the plastics material melt to fill all the parts of the mold cavity. The method comprises the steps of applying a light pressure to close the mold, injecting a predetermined quantity of molten plastics material into the mold cavity at a pressure which is such that the injection of the plastics material can cause the cavity to expand in volume against the resistance of the light closing pressure, and applying a high pressure to close the mold fully after completion of the injection step.

### SUMMARY

According to a first broad aspect of the present invention, there is provided a molding apparatus for producing a molded article from a molding material. The molding apparatus comprises an inner core and an outer core for defining a portion of a molding cavity for defining the molded article; the inner core including a compensator, the compensator being configured to: retract to a retracted position responsive to the pressure of the molding material being injected into the molding cavity; and extend to an extended position responsive to the shrinkage during solidification of the molding material in the molding cavity.

According to another broad aspect of the present invention, there is provided a method of injection-molding of a molded article from a molding material. The method comprises increasing a volume of a molding cavity, said increasing being implemented by means of the retraction of an inner core relative to an outer core and being implemented in response to the pressure of the molding material being injected into the molding cavity; decreasing the volume of the molding cavity, said decreasing being implemented by means of extension of the inner core relative to the outer core and being implemented in response to the shrinkage during the solidification of the molding material within the molding cavity.

These and other aspects and features will now become apparent to those skilled in the art upon review of the following description of specific non-limiting embodiments in conjunction with the accompanying drawings.

### DETAILED DESCRIPTION OF THE DRAWINGS

The detailed description of illustrative (non-limiting) embodiments will be more fully appreciated when taken in conjunction with the accompanying drawings, in which:

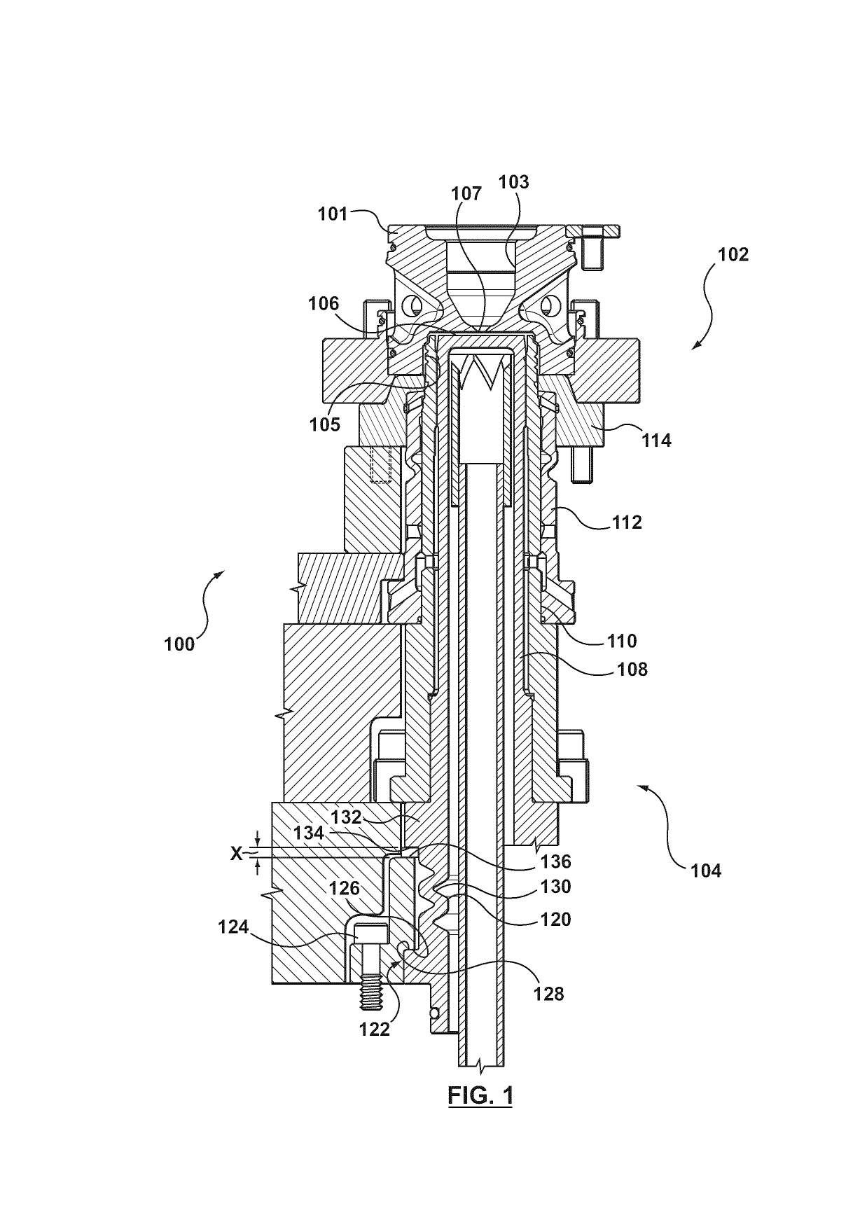

FIG. 1 shows a section view through a portion of a non-limiting embodiment of an injection mold;

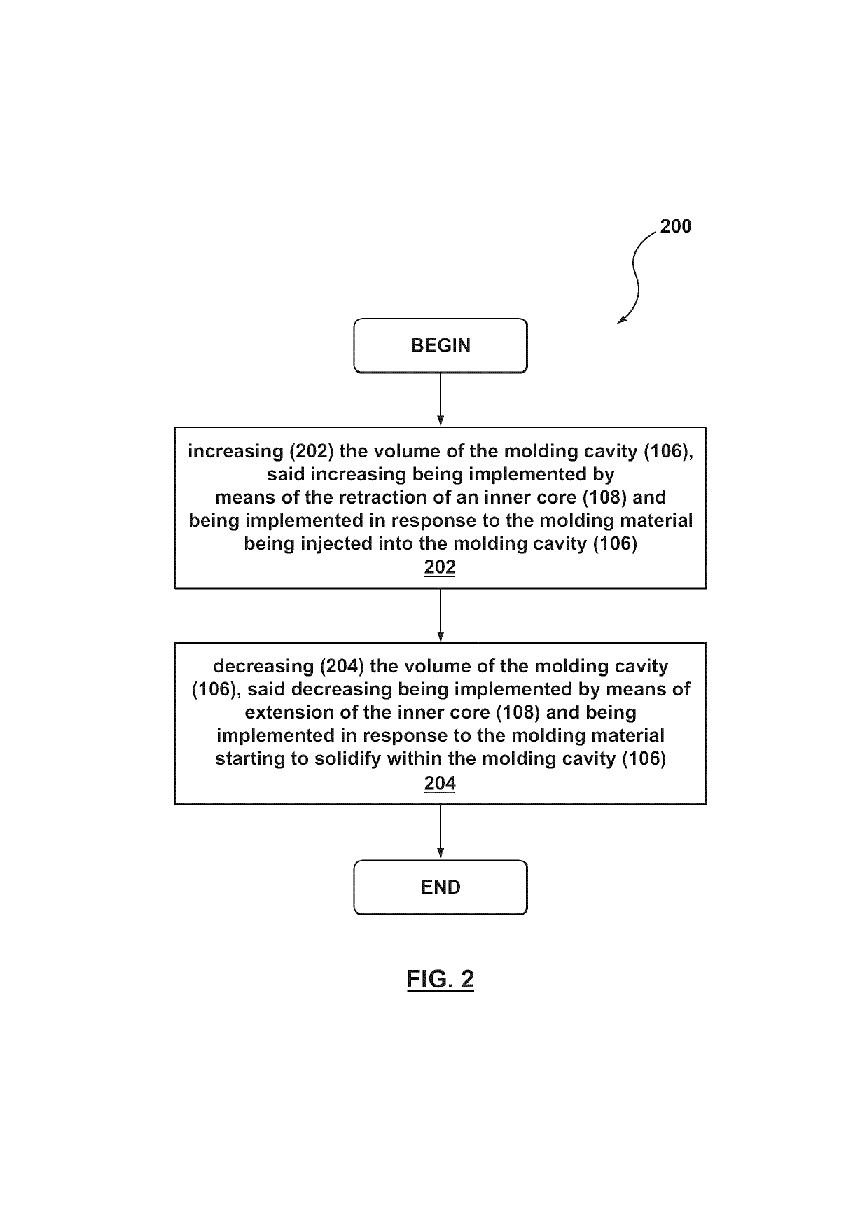

FIG. 2 depicts a flow chart of a non-limiting embodiment of a method of injection-molding implemented within the injection mold of FIG. 1.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

With reference to FIG. 1, there is depicted a section view through a portion of a non-limiting embodiment of a portion of an injection mold 100. The injection mold 100 includes a first mold half portion 102 and a second mold half portion 104 that are mounted, in use, onto platens (not depicted) of an injection molding machine (not shown) for a repositioning thereof between a mold-closed configuration, as shown in FIG. 1, and a mold-open configuration, which is not shown in the illustrations.

Generally speaking, in the mold-closed configuration, portions of the first mold half portion 102 and the second mold half portion 104 cooperate to define a molding cavity 106 for producing therein a molded article (not depicted) from molding material delivered into the molding cavity 106, under injection pressure, from an injection unit (not depicted), typically, via a hot runner (not depicted). In the mold-open configuration, the first mold half portion 102 and the second mold half portion 104 are typically separated by a sufficient distance for allowing the molded article (not depicted) to be stripped and removed from within the molding cavity 106. An example of the molded article that can be produced within the molding cavity 106 can include a closure having a thread region 105 of a type for releasably capping a beverage container, but other types of molded article can also be moldable within the molding cavity 106. Within the non-limiting example of the molded article being implemented as a closure, the molding material can comprise high-density polyethylene (HDPE) or Polypropylene (PP).

Within the illustrative embodiments depicted within FIG. 1, the first mold half portion 102 includes a gate insert 101. The gate insert 101 defines a nozzle receptacle 103 for accepting, in use, a nozzle of a hot runner (not depicted). The gate insert 101 further defines a portion of the molding cavity 106 and a gate 107 for communicating molding material between the hot runner nozzle (not depicted) and the molding cavity 106. Even though the gate insert 101 is depicted as a one-piece structure, which defines the nozzle receptacle 103 on one side thereof and the molding cavity 106 on the other side thereof, in alternative embodiments of the present invention, a separate insert (not depicted) can be used to define a portion of the molding cavity 106 which in the present invention is defined by the gate insert 101. In other words, the gate insert 101 can be implemented as a two-piece assembly in alternative embodiments of the present invention.

Within the illustrative embodiments depicted within FIG. 1, the second mold half portion 104 includes an inner core 108, an outer core 110, and a slide pair 114 with which to define an inner portion and a tamper-evident ring portion of the molding cavity 106, respectively. The second mold half portion 104 also includes a stripper sleeve 112, which main function includes stripping the molded article (not depicted) from the outer core 110.

The inner core 108 has a cylindrical body around which a tubular body of the outer core 110 is slidably arranged to accommodate relative movement thereof, along the mold-stroke axis, whereby a part of the molded article (not depicted) is releasable from therebetween. The stripper sleeve 112 also has a tubular body that is slidably arranged around the outer core 110 to accommodate a relative movement therebetween, along the mold-stroke axis, whereby the slide pair 114 are openable and the molded article is strippable from the outer core 110.

Operation of the inner core 108, outer core 110 and the slide pair 114 is generally known in the art and will not be discussed here at any length. Suffice it to state, for the sake of completeness, that the inner core 108, outer core 110 and the slide pair 114 cooperate, in a sliding manner relative to each other, in order (i) to define various portions of the inner and outer surfaces (such as, the inner skin, various portions of the thread, various sealing features and the like) of the molded article which is being illustrated as a closure; and (ii) by sliding relative to each other, to then release the molded article being illustrated as a closure for the sake of stripping and releasing thereof.

In the present non-limiting embodiment, the stripper sleeve 112 defines a portion of the molding cavity 106. That being said, in another non-limiting embodiment, not shown, the stripper sleeve 112 may have an alternative structure wherein it does not define any portion of the molding cavity 106.

It is noted that the first mold half portion 102 and the second mold half portion 104 have a number of additional components, which are implemented generally in line with the teachings in the art and, as such, will not be discussed here at any great length.

According to embodiments of the present invention, the second mold half portion 104 further comprises a compensator 120. The second mold half portion 104 further includes a retainer 122. Generally speaking, the purpose of the retainer 122 is to couple, in use, the inner core 108 to a core plate (not depicted). In the presently illustrated embodiment this is done by means of a screw 124, however, other coupling means can, of course, be used. Even though not clearly visible within the illustration of FIG. 1, the retainer can be implemented in two complementary split halves.

The retainer 122 includes a first shoulder 126 and the inner core 108 includes a second shoulder 128. The first shoulder 126 engages, in use, the second shoulder 128, to retain the inner core 108 in place vis-à-vis the core plate (not depicted).

In the presently illustrated embodiment, the compensator 120 comprises a spring-like portion 130 defined on the inner core 108. In other words, it can be said that the compensator 120 is a portion of the inner core 108 that demonstrates a degree of resiliency that allows the inner core 108 to move along the axial direction (i.e. the direction of operation—opening and closing thereof) of the injection mold 100. Put yet another way, in the illustrated embodiment, the compensator 120 being implemented as the spring-like portion 130 is integrally made with the remainder of the inner core 108. It is noted that this needs not be so in every embodiment of the present invention. For example, in an alternative non-limiting embodiment, the compensator 120 can be implemented as a separate spring-like/resilient member and coupled to the remainder of the inner core 108 by suitable means.

The inner core 108 comprises a shoulder 132, the shoulder 132 having a lower landing 134. The retainer 122 comprises an upper landing 136. A distance “X” is defined between the lower landing 134 and the upper landing 136. It is the distance “X” that delimits the path of travel for the inner core 108 between the fully extended position, as is depicted in FIG. 1, and a fully retracted position, which is not depicted, but in which the lower landing 134 abuts the upper landing 136. Needless to say, the path of travel for the inner core 108 can be delimited by other means. For example, in alternative embodiments of the present invention the shape of the spring-like portion 130 can be selected such that it “bottoms out” in the fully retracted position or, in other words, the S-shape landings abut each other and, thus, prevent the inner core 108 from retracting any further. In yet other alternative embodiments of the present invention, the material used for making the spring-like portion 130 can be selected such that to provide only a pre-determined degree of movement, therefore, inherently limiting the path of travel for the inner core 108.

As has been previously explained, the function of the compensator 120 is to allow a degree of movement for the inner core 108 in the axial direction of the injection mold 100. Effectively, what it allows to do is to selectively change the volume of the molding cavity 106. It is worthwhile noting that the movement of the inner core 108 is actuated by the movement and subsequent solidification (and, therefore, shrinkage) of the molding material within the molding cavity 106. More specifically, as the molding material is being injected into the molding cavity 106, under the pressure of the molding material being so-injected, the inner core 108 is pushed rearwardly, effectively increasing the volume of the molding cavity 106. This rearward movement is allowed for by the compensator 120. This movement will continue until the inner core 108 reaches the retracted position, which in the illustrated embodiment of FIG. 1 is illustrated by means of the distance “X”.

Then, as the molding material starts to solidify within the molding cavity 106 and, responsive to the solidification of the molding material, the molding article starts to shrink, the compensator 120 biases the inner core 108 towards the extended position, effectively decreasing the volume of the molding cavity 106. A technical effect of embodiments of the present invention includes ability to compensate for the shrinkage of the molded article by decreasing the volume of the molding cavity 106 as the molded article shrinks. This, in turn, may allow early start to the plasticizing, as the traditional step of holding (i.e. the process when holding pressure is used to inject small amounts of material into the molding cavity 106 to compensate for the molded article shrinkage—during which phase plasticizing is not generally possible). This in turn may allow to further decrease the overall molding cycle, by effectively over-laying certain portions of the molding cycle (i.e. starting plactising for the next molding cycle while the compensator 120 effectively implements the shrinkage-compensation function previously implemented by the holding function).

In other words, it can be said that the compensator 120 is configured to (i) retract to a retracted position responsive to the pressure of the molding material being injected into the molding cavity; and (ii) extend to an extended position responsive to the shrinkage during the molding material solidifying in the molding cavity to allow the inner core 108 to move between the respective positions as well.

Even though the illustrated embodiment of FIG. 1 implements the compensator 120 as the spring-like portion 130, other executions are possible in alternative non-limiting embodiments of the present invention. For example, whereby in the illustrated embodiment, the compensator is implemented as a passive member (i.e. its retraction is actuated exclusively by the in-flow of the molding material and its extension is triggered exclusively by the shrinkage of the molded article), in alternative embodiments, the compensator 120 can be implemented as a semi-passive member. For example, in one alternative non-limiting embodiment, the compensator 120 can be implemented as an active-material-based member (for example, using piezo-electric components and the like), whereby its retraction can be triggered by the in-flow of the molding material, while the extension can be actuated by means of the active-material-based member, which can as an element of injection-compression to the process. Other alternatives are also possible. For example, the resiliency/elasticity of the compensator 120 can be based not on the geometry thereof, but on the selection of material to make the compensator 120.

Given the architecture of the inner core 108 and, specifically, the compensator 120 described above, it is possible to execute a method for molding a molded article, a non-limiting embodiment of a method 200 being depicted with reference to FIG. 2.

Step 202—Increase the Volume of the Molding Cavity 106

The method 200 begins at step 202, where the volume of the molding cavity 106 is increased by means of the retraction of the inner core 108. Within embodiments of the present invention, retraction of the inner core 108 is implemented by means of the compensator 120 and is executed in response to the pressure of the molding material being injected into the molding cavity 106 under injection pressure. Put another way, step 202 is implemented in a passive manner and is triggered by means of the in-cavity pressure generated by the inflow of the molding material.

Step 204—Decrease the Volume of the Molding Cavity 106

The method 200 then continues to step 204, where the volume of the molding cavity 106 is decreased by means of the extension of the inner core 108. The decrease of the volume of the molding cavity 106 is executed in order to compensate for the molding material shrinkage. In embodiments of the present invention, the extension of the inner core 108 is executed by means of the compensator 120 and, more specifically, by the compensator 120 biasing the inner core 108 to the extended position. The extension is triggered by the shrinkage of the molded article as the molding material in the molding cavity 106 starts and continues to solidify and, naturally, shrinks.

In alternative embodiments of the method 200, especially applicable but not limited to those embodiments where the compensator 120 is implemented as an active material member, for instance, steps 202 and step 204 can be implemented by controlling (for example, activating and se-activating) the active material element, instead of relying exclusively on the molding material pressure for step 202 and resilience of the spring-like portion 130 for executing step 204.

It is noted that the concept of the compensator 120 can be applied to other portions of the injection mold 100, such as for example depicted in FIG. 1, a structure similar to the compensator 120 can be defined on the stripper sleeve 112. In other words, in alternative embodiments (not depicted) of the present invention, the stripper sleeve 112 can comprises a compensator, such as a structure similar to the spring-like portion 130, to allow the stripper sleeve 112 a degree of movement in a direction substantially along the mold-stroke axis.

It is noted that the foregoing has outlined some of the more pertinent non-limiting embodiments. These non-limiting embodiments may be used for many applications. Thus, although the description is made for particular arrangements and methods, the intent and concept of these non-limiting embodiments may be suitable and applicable to other arrangements and applications. It will be clear to those skilled in the art that modifications to the disclosed non-limiting embodiments can be effected. The described non-limiting embodiments ought to be construed to be merely illustrative of some of the more prominent features and applications thereof. Other beneficial results can be realized by applying these non-limiting embodiments in a different manner or modifying them in ways known to those familiar with the art. This includes the mixing and matching of features, elements and/or functions between various non-limiting embodiments is expressly contemplated herein, unless described otherwise, above.

What is claimed is:

1. A molding apparatus for producing a molded article from a molding material, comprising:
an inner core (108) and an outer core (110) for defining a portion of a molding cavity (106) for defining the molded article;
the inner core (108) including a compensator (120), the compensator (120) being configured to:
retract to a retracted position responsive to the pressure of the molding material being injected into the molding cavity (106); and
extend to an extended position responsive to the shrinkage during solidification of molding material in the molding cavity.

2. The molding apparatus of claim 1, wherein the compensator (120) comprises a spring-like portion (130).

3. The molding apparatus of claim 2, wherein the spring-like portion (130) biases the inner core (108) towards the extended position.

4. The molding apparatus of claim 2, wherein the spring-like portion (130) is resilient and its resiliency is based on at least one of (i) geometry of the spring-like portion (130) and (ii) selection of material for the spring-like portion (130).

5. The molding apparatus of claim 1, wherein the compensator (120) is configured to allow the inner core (108) to extend and retract over a path of travel “X”.

6. The molding apparatus of claim 5, the molding apparatus further comprising a retainer (122) for coupling the inner core (108) to a core plate, and wherein the retainer (122) and the inner core (108) cooperate to delimit the path of travel “X”.

7. The molding apparatus of claim 5, wherein the path of travel “X” is delimited by selection of geometry for a spring-like portion (130).

8. The molding apparatus of claim 5, wherein the path of travel “X” is delimited by selection of material for a spring-like portion (130).

9. The molding apparatus of claim 1, wherein the compensator (120) is capable to allow the inner core (108) to move between retracted and extended positions passively in response to the pressure of the molding material being injected into the molding cavity and during solidification of the molding material, respectively.

10. The molding apparatus of claim 1, wherein the compensator (120) comprises an active-material-based member.

11. The molding apparatus of claim 1, wherein the compensator (120) comprises a spring-like portion (130) and wherein the spring-like portion (130) is one of: (a) integrally made with the remainder of the inner core (108) and (b) coupled to the remainder of inner core (108).

12. The molding apparatus of claim 1, wherein the compensator (120) comprises a spring-like portion (130) and wherein the spring-like portion (130) is defined by a portion of the inner core (108).

13. A method (200) of injection-molding of a molded article from a molding material, the method comprising:
increasing (202) a volume of a molding cavity (106), said increasing being implemented by means of retraction of an inner core (108) relative to an outer core (110) and being implemented in response to the pressure of the molding material being injected into the molding cavity (106);
decreasing (204) the volume of the molding cavity (106), said decreasing being implemented by means of extension of the inner core (108) relative to the outer core and being implemented in response to shrinkage during solidification of molding material within the molding cavity (106).

14. The method (200) of claim 13, wherein said increasing is implemented by means of a compensator (120) associated with the inner core (108).

15. The method (200) of claim 13, wherein said decreasing is implemented by means of a compensator (120) associated with the inner core (108).
